(19) United States
(12) Patent Application Publication
(10) Pub. No.: US 2026/0161377 A1
(43) Pub. Date: Jun. 11, 2026

(54) System and Method for Role Based Access Control for a Storage System

(71) Applicant: Dell Products L.P., Round Rock, TX (US)

(72) Inventors: Hitesh V, Bengaluru (IN); Emily Liu, Shanghai (CN); Tracy Lv, Shanghai (CN); Qiancheng Liang, Shanghai (CN); Eric Jiang, Shanghai (CN); Plocen Geng, Shanghai (CN); Hari Prasad Chandrasekaran, Bengaluru (IN)

(21) Appl. No.: 18/971,232

(22) Filed: Dec. 6, 2024

(51) Int. Cl. G06F 8/61

(52) U.S. Cl. CPC G06F 8/61

(57) ABSTRACT

A method, computer program product, and computing system for installing a middleware plug-in on a server connected to a storage area network (SAN) environment including a plurality of pre-existing storage controllers and a corresponding plurality of distinct storage resources. The method, computer program product, and computing system may further include defining a plurality of storage resource pools (SRPs) through the middleware plug-in, populating each SRP with one or more storage resources, defining one or more user-roles through the middleware plug-in, associating each SRP with a designated user-role, and assigning each end-user to one or more user-roles through the middleware plug-in.

### BACKGROUND

Storing and safeguarding electronic content may be beneficial in modern business and elsewhere. Accordingly, various methodologies may be employed to protect and distribute such electronic content.

For example, consider a storage controller used to manage a collection of storage resources for an organization. At present, in order for the storage controller to be able to perform any action on a storage resource, that storage resource must first be registered with the storage controller. Once registered, any users are granted access through the storage controller and are then able to access any storage resource currently registered with the storage controller. Assuming the organization has several departments and has created separate storage resources for each department, current approaches provides no limitations or restrictions for any user granted access to any registered resource. As such, any user granted access will be able to access any registered storage resources regardless of which department they work in, and regardless of which department a given storage resource was intended to be used by.

This one-size-fits-all approach to granting user access exposes potentially confidential storage resources to unverified users and may result in unintended confusion and inefficiency due to human error, or breaches in security due to more malicious user activity.

### SUMMARY OF DISCLOSURE

In one example implementation, a computer-implemented method executed on a computing device may include, but is not limited to, installing a middleware plug-in on a server connected to a storage area network (SAN) environment including a plurality of pre-existing storage controllers and a corresponding plurality of distinct storage resources. The method may further include defining a plurality of storage resource pools (SRPs) through the middleware plug-in, populating each SRP with one or more storage resources, defining one or more user-roles through the middleware plug-in, associating each SRP with a designated user-role, and assigning each end-user to one or more user-roles through the middleware plug-in.

One or more of the following example features may be included. The middleware plug-in may be configured to act as an intermediary between the plurality of pre-existing storage controllers and the corresponding plurality of distinct storage resources. Each distinct storage resource may include one or more storage resources that share a common storage format. Each user role may be configured to provide end-users with limited access to an associated SRP. The one or more storage resources populating each SRP may be selected from any of the one or more distinct storage resources. Each SRP may be configured to be cross-compatible with one or more different storage formats simultaneously. Each user role may be configured to apply a pre-determined set of policies through the middleware plug-in. Each SRP may be configured to receive a pre-determined set of services through the middleware plug-in.

In another example implementation, a computing system includes at least one processor and at least one memory architecture coupled with the at least one processor, where the at least one processor is configured to install a middleware plug-in on a server connected to a storage area network (SAN) environment, the SAN environment including a plurality of pre-existing storage controllers and a corresponding plurality of distinct storage resources, to define a plurality of storage resource pools (SRP), to populate each SRP with one or more storage resources, to define one or more user-roles, to associate each SRP with a designated user-role, and to assign each end-user to one or more user roles.

One or more of the following example features may be included. Each user role may be configured to provide end-users with limited access to an associated SRP. The one or more storage resources populating each SRP may be selected from any of the one or more distinct storage resources, and where each SRP may be configured to be cross-compatible with one or more different storage formats simultaneously. Each user role may be configured to apply a pre-determined set of policies through the middleware plug-in. Each SRP may be configured to receive a pre-determined set of services through the middleware plug-in.

In another example implementation, a computer program product resides on a computer readable medium that has a plurality of instructions stored on it. When executed by a processor, the instructions cause the processor to perform operations that may include, but are not limited to, defining a plurality of SRPs (storage resource pools); populating each SRP with one or more storage resources; defining one or more user-roles; associating each SRP with a designated user-role; and assigning each end-user to one or more user roles.

One or more of the following example features may be included. The one or more storage resources populating each SRP reside on one of a plurality of distinct storage resources, where the one or more storage resources may share a common storage format. The one or more storage resources populating each SRP may be selected from any of the one or more distinct storage resources, where each SRP may be configured to be cross-compatible with one or more different storage formats simultaneously. Each user role may be configured to provide end-users with limited access to an associated SRP. Each user role may be configured to apply a pre-determined set of policies. Each SRP may be configured to receive a pre-determined set of services.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a data ownership process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the role-based access control (RBAC) process of FIG. 1 according to one or more example implementations of the disclosure;

FIG. 4 is an example diagrammatic view of an unmodified storage system without RBAC; and

FIG. 5-8 are example diagrammatic views of modified storage systems with RBAC according to one or more example implementations of the disclosure.

Like reference symbols in the various drawings indicate like elements.

### DETAILED DESCRIPTION

### System Overview:

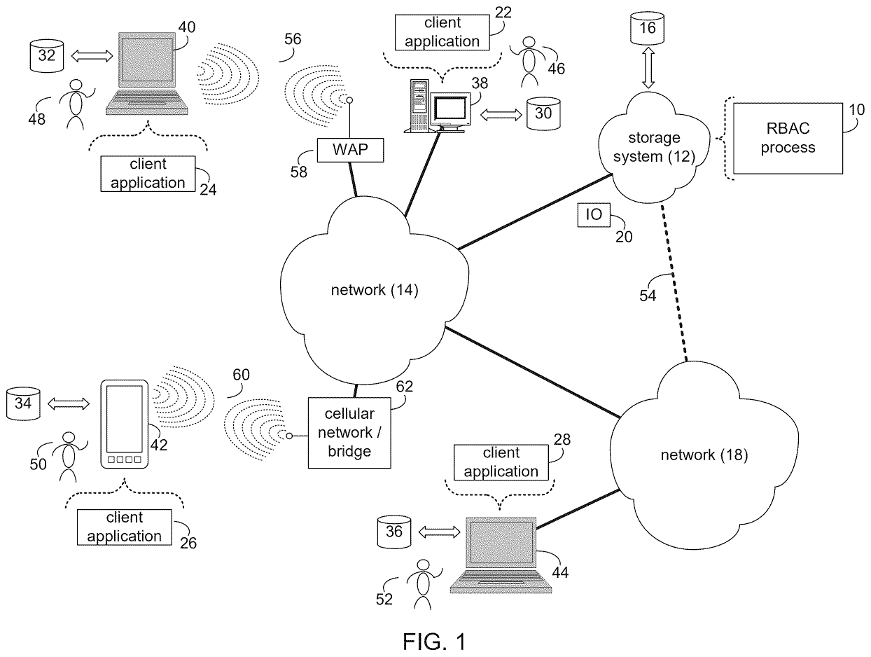

Referring to FIG. 1, there is shown role-based access control (RBAC) process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini-computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of RBAC process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of RBAC process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data ownership process, such as RBAC process 10 of FIG. 1, may include but is not limited to, installing a middleware plug-in on a server connected to a storage area network (SAN) environment including a plurality of pre-existing storage controllers and a corresponding plurality of distinct storage resources. The method may further include defining a plurality of storage resource pools (SRPs) through the middleware plug-in, populating each SRP with one or more storage resources, defining one or more user-roles through the middleware plug-in, associating each SRP with a designated user-role, and assigning each end-user to one or more user-roles through the middleware plug-in.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

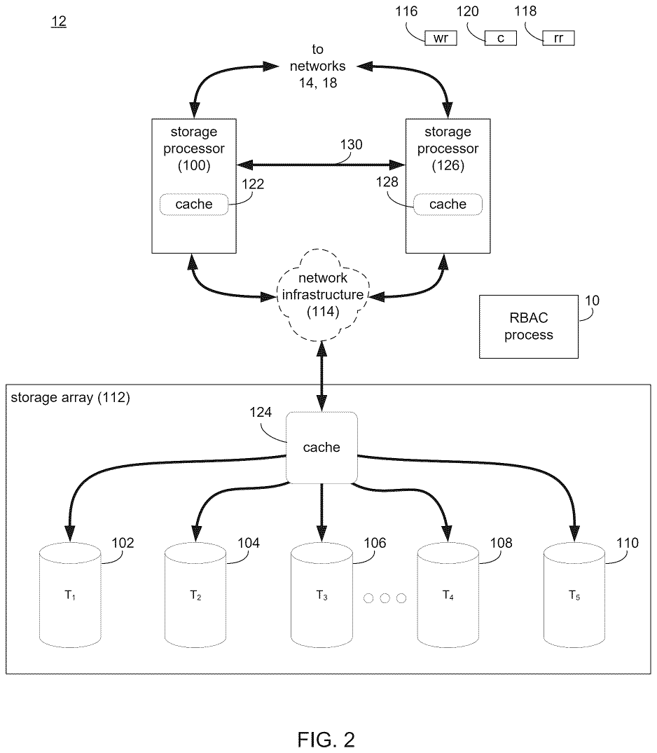

Referring also to FIG. 2, storage system 12 may include storage processor 100 and a plurality of storage targets T1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of RBAC process 10. The instruction sets and subroutines of RBAC process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of RBAC process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of RBAC process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of RBAC process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of RBAC process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of RBAC process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where the processing of data by one storage processor may be synchronized to the other storage processor. For example, data may be synchronized between each storage processor via a separate link or connection (e.g., connection 130).

### The Role Based Access Control (RBAC) Process:

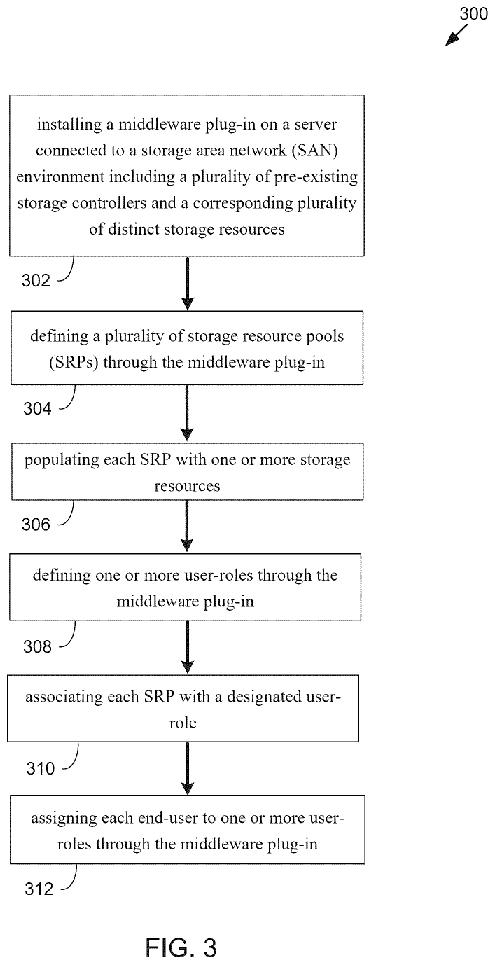

Referring also to FIGS. 3-8 and in some implementations, RBAC process 10 may include installing (302) a middleware plug-in on a server connected to a storage area network (SAN) environment including a plurality of pre-existing storage controllers and a corresponding plurality of distinct storage resources, defining (304) a plurality of storage resource pools (SRPs) through the middleware plug-in, and populating (306) each SRP with one or more storage resources. RBAC process 10 may further include defining (308) one or more user-roles through the middleware plug-in, associating (310) each SRP with a designated user-role, and assigning (312) each end-user to one or more user-roles through the middleware plug-in.

In some implementations and as will be discussed in greater detail below, RBAC process 10 may restrict end-users from accessing volumes, file shares, etc., (i.e., “storage containers”), hosted on enterprise-level storage solutions, (i.e., “storage resources”), via a centralized management platform (i.e., a “storage controller”) from having unlimited access to all of the available storage resources hosted thereon. Instead, RBAC process 10 may create groupings of storage resources (i.e., “storage resource pools” (SRPs)), and may define specific user roles associated with each SRP such that end users may be assigned dedicated user roles. Accordingly, end-users may only be allowed to access the storage resources included in the SRP associated with their assigned user roles.

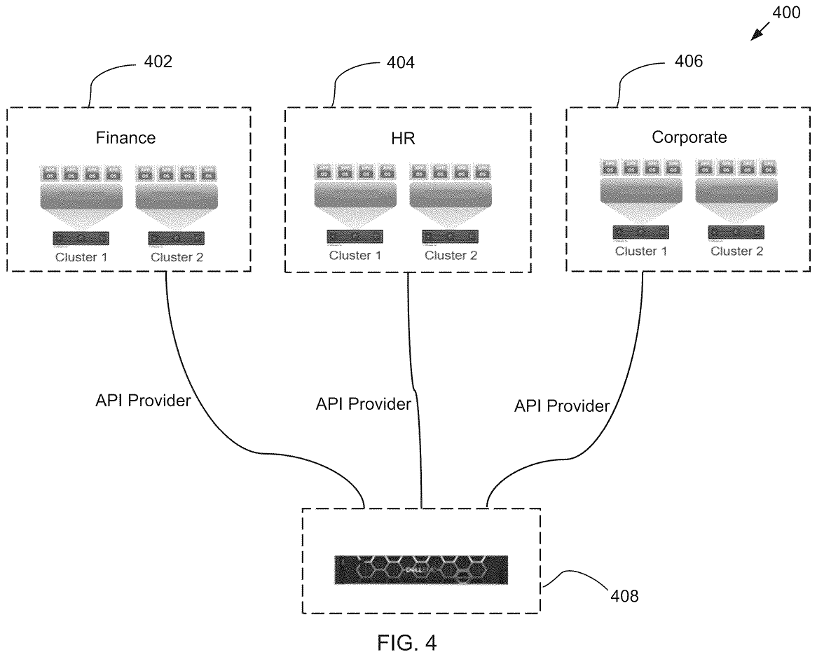

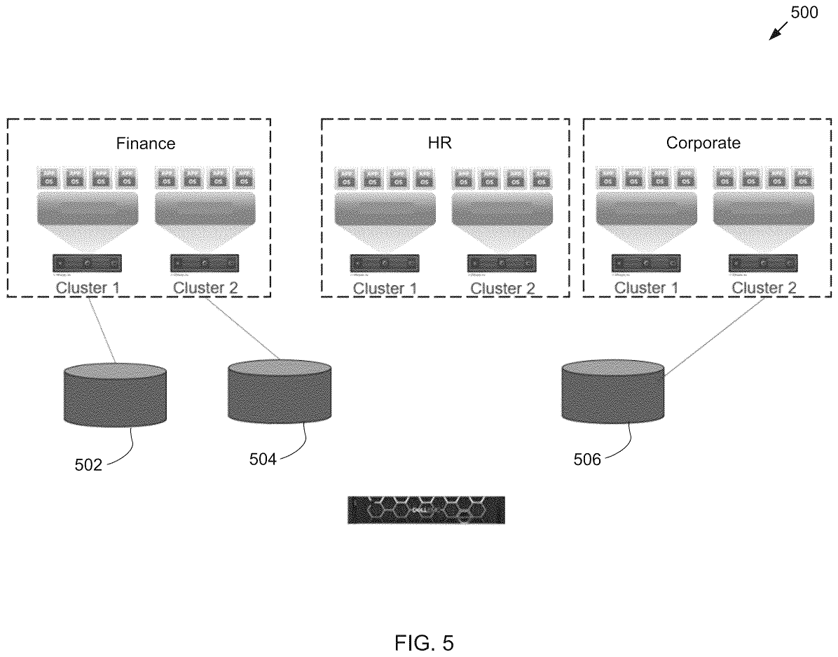

Consider examples 400 and 500 shown in FIGS. 4-5, a company having three departments: HR, Finance, and Corporate, where each department has its own separate storage controller, 402, 404, 406, respectively. Further, each department may access a shared storage resource 408 via an application programming interface (API) service provided by shared storage resource 408. The company may want each department to only be able to access select storage resources 502, 504, 506 reserved exclusively for their own use in order to achieve a data segregation goal, as shown in example 500 in FIG. 5. However, the reality is that without RBAC being implemented, any user-access provided through storage controller 408 will allow end-users to see and access all storage resources from all storage resources 402, 404, 406 so long as an API service provider connection exists, as shown in example 400 in FIG. 4. As such, without RBAC there is no way to guarantee that the reserved storage resources will only be accessible by the appropriate department.

In this example, suppose a SAN environment is being used for storing various types of data (e.g., financial, human resources, etc.) and a user desires to limit access to each type of data based on a given user's role, as shown in FIG. 5. After the implementation of role-based access control (RBAC), storage resources 502 and 504, may only be accessed by users assigned to the finance user role, while storage resource 506 may only be accessed by users assigned to the corporate user role, and users assigned to the HR user role are not allowed to access any of storage resources 502, 504, 506.

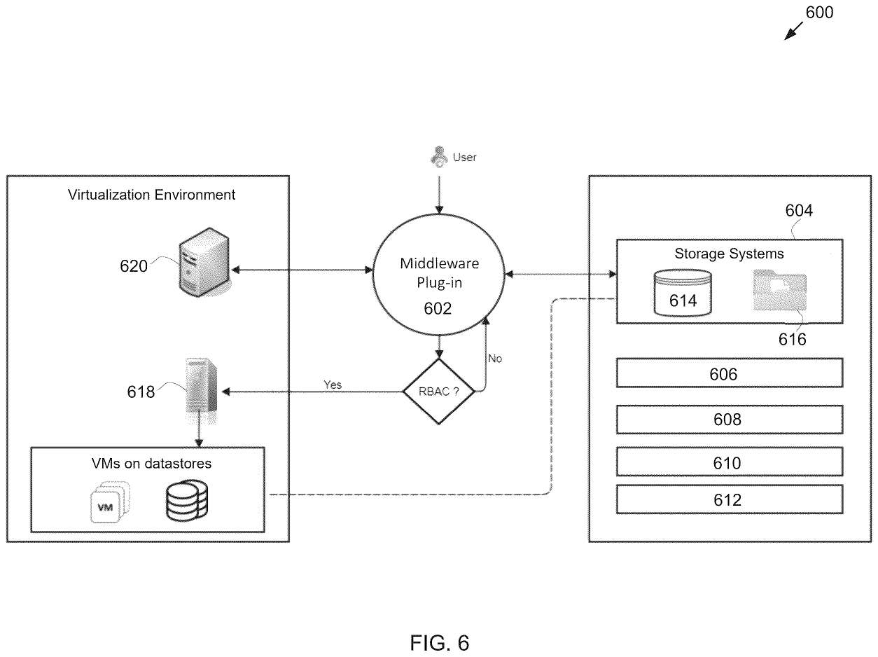

In some implementations, RBAC process 10 installs 302 a middleware plug-in on a server connected to a storage area network (SAN) environment including a plurality of pre-existing storage controllers and a corresponding plurality of distinct storage resources. For example and as shown in FIG. 6, RBAC process 10 installs 302 middleware plug-in 602, where middleware plug-in 602 acts as a buffer layer between storage resources 604, 606, 608, 610, 612, and storage controller 614. Middleware plug-in 602 has the ability to manage storage resources 604, 606, 608, 610, 612, and any storage resources included therein (e.g., storage resources 614, 616). Further middleware plug-in 602 may be used to perform integrations between these storage resources per business requirements. In some implementations, middleware plug-in 602 may be a web application configured to add any logic control, like storage-based RBAC in this buffer layer before going forward to perform operations, like creating storage resources or managing virtual machines (VMs).

In some implementations, middleware plug-in 602 introduces the ability to register storage resources 604, 606, 608, 610, 612, with administrative credentials, such that middleware server 618 maintains the connections to storage resources 604, 606, 608, 610, 612, in the backend, and uses these connections to perform create, read, update, and/or delete (CRUD) operations on storage resources based on RBAC associated storage resource pools (SRPs). Further, middleware plug-in 602 also introduces the ability to register storage controller 620 with admin credentials, such that middleware server 618 maintains the connection to storage controller 620 in the backend, and uses these connections to query or create storage resources (e.g., volumes, storage resources, etc.), and implement RBAC based on these resources.

In some implementations, middleware plug-in 602 introduces the ability to register storage API providers to a storage resource (e.g., storage resources 604, 606, 608, 610, 612), which may also be a prerequisite for some virtual volumes (vVol) datastores. Further, middleware plug-in 602 introduces the ability to create and manage storage resource pools (SRPs), where each pool can contain multiple vVol resources (e.g., storage resources 614, 616) from multiple storage resources. Further, in some implementations, each SRP may be configured to receive a pre-determined set of services through the middleware plug-in. For example, it may be desirable to enforce certain minimum requirements for the size and configuration of storage resources, and middleware plug-in 602 can perform regular checks to ensure that these minimum requirements are being met.

In some implementations, RBAC process 10 defines (304) a plurality of storage resource pools (SRPs) through the middleware plug-in and populates (306) each SRP with one or more storage resources, where each SRP is an access control unit that can contain multiple storage resources, and where each storage resource can come from any one of a number of heterogeneous storage resources.

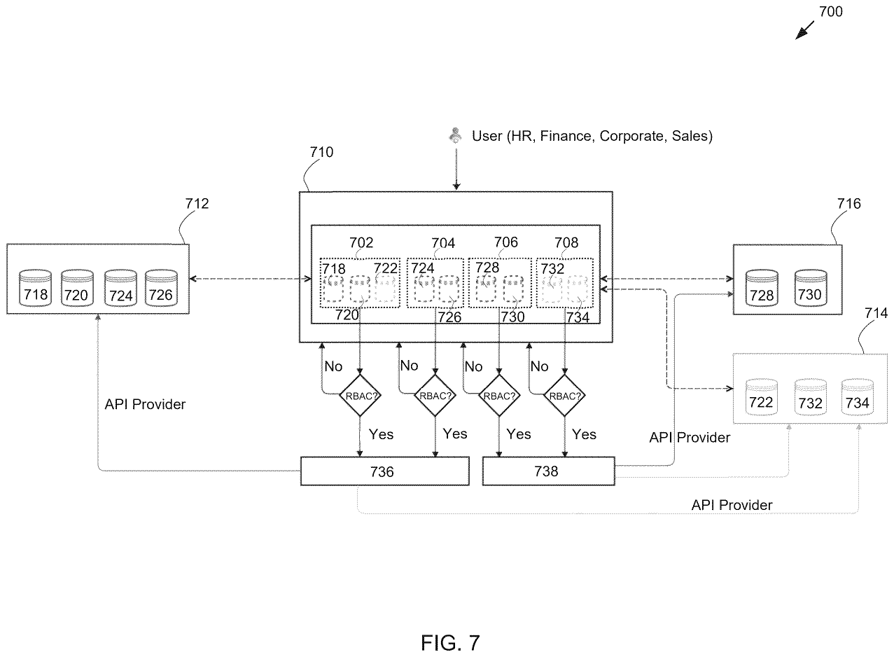

For example and as shown in FIG. 7, RBAC process 10 defines (304) a plurality of storage resource pools (SRPs) (e.g., SRPs 702, 704, 706, 708) through the middleware plug-in (e.g., middleware plug-in 710). Each SRP may include storage resources originating from any one of a number of heterogeneous storage resources (e.g., storage resources 712, 714, 716). Further, each heterogeneous storage resource may make use of a different storage scheme or format, for example, a virtual machine file system (VMFS) as opposed to a network file system (NFS). Accordingly, each SRP is configured to access storage resources that potentially make use of a plurality of different storage schemes or formats and is cross-compatible with a variety of different storage formats.

In some implementations, RBAC process 10 defines (308) one or more user-roles through the middleware plug-in, associates (310) each SRP with a designated user-role, and assigns (312) each end-user to one or more user-roles through the middleware plug-in. For example, end-users defined through middleware plug-in 710 can be adopted from user accounts created in any of the storage controllers or can leverage active directory domain user accounts. Regardless of where a user account originates from, by default middleware plug-in 710 is configured to interact with the end-user based on permissions defined in middleware plug-in 710. For example, the end-user will only be able to access storage resources based on the user role assigned to the user account and the SRP affiliated with the assigned user role. Further, in some implementations, each user role is configured to apply a pre-determined set of policies through the middleware plug-in. For example, security policies may define zero-access windows where no end-users are allowed to login so that routine maintenance can be performed.

Referring again to example 700, suppose a SAN environment is being used for storing various types of data (e.g., financial, human resources, etc.) and a user desires to limit access to each type of data based on a given user's role, as shown in FIG. 7. A first SRP 702 is created to include two storage resources (e.g., storage resources 718, 720) from a first storage resource 712, and one storage resource (e.g., storage resource 722) from a second storage resource 714. Once created, SRP 702 may be associated with the “HR” user role. A second SRP 704 is created to include two different storage resources (e.g., storage resources 724, 726) from first storage resource 712. Then once created SRP 704 may be associated with the “Finance” user role. A third SRP 706 is created to include two storage resources (e.g., storage resources 728, 730) from a third storage resource (e.g., storage resource 716). Then once created SRP 706 may be associated with the “Corporate” user role. A fourth SRP 708 is created to include two different storage resources (e.g., storage resources 732, 734) from storage resource 712. Once created, SRP 708 may be associated with the “Sales” user role. All three storage resources 712, 714, 716 are operably connected to one or more storage controllers (e.g., storage controllers 736, 738) via an API service provider connection.

According to example 700, shown in FIG. 7, an implementation of RBAC process 10 allows for the mixing and matching of storage resources from a plurality of heterogeneous storage resources as illustrated by first SRP 702 including storage resources from first storage resource 712 and second storage resource 714. An implementation of RBAC process 10 also allows for the sub-division of storage resources from a single storage resource among multiple SRPs as illustrated by first SRP 702 and second SRP 704 both having storage resources from first storage resource 712, specifically storage resources 718, 720, 724, 726 respectively. A similar sub-division is illustrated by first SRP 702 and fourth SRP 704 both having storage resources from second storage resource 714.

In some implementations, storage controllers 736, 738 may not normally support the full span of management features provided by middleware plug-in 710. In these cases, middleware plug-in 710 fills in the gap and effectively expands the range of management options available.

In some implementations, the more granular access control across multiple storage controllers and heterogenous storage resources may be extendable, because RBAC can be applied to other storage resource types, like VMFS, NFS, etc. RBAC can also be applied to other objects created by the storage controller (e.g., hosts, clusters, etc.). The extent of use only depends on the business requirement for a given set of circumstances.

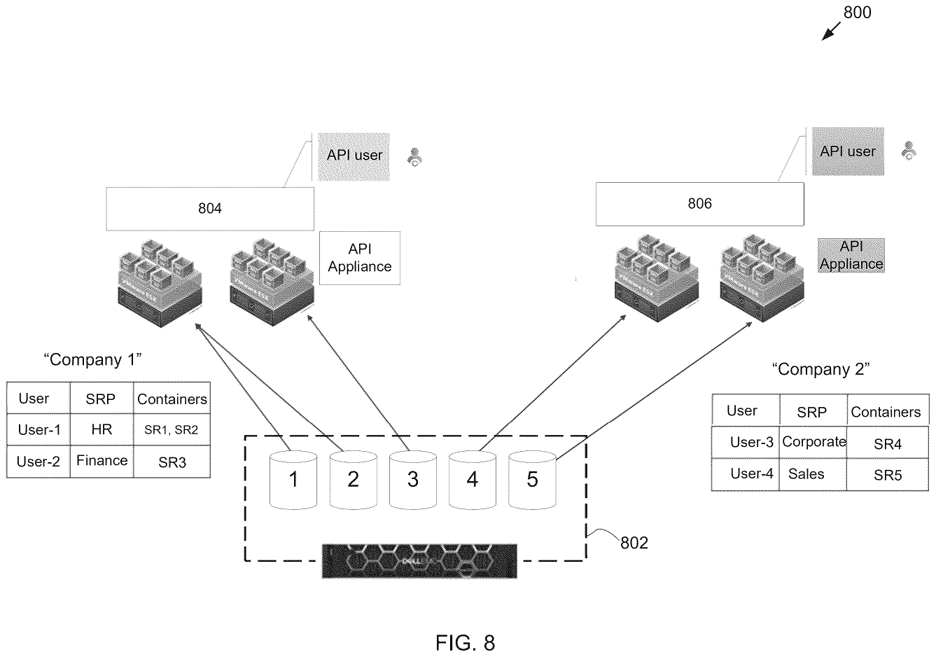

Further, the middleware implemented RBAC is flexible and extendable enough to support multi-tenant usage scenarios. In some implementations, the middleware plug-in may be used to design multi-level RBAC, for example, a 1^{st} level: for end-users from different companies and a 2^{nd} level for end-users in different departments within the company. In example 800 shown in FIG. 8, multiple companies may have one or more storage resources (e.g., storage resource 802) in common. Storage resource 802 may include a plurality of storage resources that are accessed by two different companies (e.g., “Company 1” and “Company 2”). Implementation of RBAC through a middleware plug-in can reorganize the plurality of storage resources into a smaller more manageable number of SRPs (e.g. SRPs 1, 2, 3, 4, 5). “Company 1” may use a first storage controller 804 to access first SRP 1 and second SRP 2 and associate the SRPs with an “HR” user role, and “Company 1” may access third SRP 3 to be associated with a “Finance” user role. While “Company 2” may use a second storage controller 806 to access fourth SRP 4 to be associated with a “Corporate” user role, and to access fifth SRP 5 to be associated with a “Sales” user role.

According to example 800, shown in FIG. 8, implementation of RBAC process 10 allows different entities to access one or more SRPs from a common storage resource, to segregate the data on the storage resource, and to further subdivide access to the one or more SRPs within their own organization. This is illustrated by “Company 1” only having access to SRPs 804, 806, 808, and further restricting access to first SRP 1 and second SRP 2 to end-users with the “HR” user role while restricting access to third SRP 3 to end-users with the “Finance” user role. Similarly, “Company 2” only has access to SRPs 4, 5, and further restricts access to fourth SRP 4 to end-users with the “Corporate” user role, while restricting access to fifth SRP 5 to end-users with the “Sales” user role. In one example, SRPs may be from a common storage format. In another example, SRPs may include storage resources with distinct formats (e.g., File, Block, or Object).

In some implementations, the middleware plugin can manage multiple storage resources across multiple storage controllers, and maintain the same user experience for end-users across multiple different storage resources, even if they employ different storage formats. Further, the middleware plug-in does not rely on each storage resource to implement its own storage-based RBAC on the storage side. This is because all of the logic used to implement RBAC is provided by the middleware plug-in, and the middleware plug-in can be installed anywhere. For example, and referring again to FIG. 6 the middleware plug-in 602 is installed on a middleware server 618, and middleware server 618 exists in a virtual environment separate from the storage resources. In some implementations, middleware server 618 may be the same machine hosting the storage controller. Effectively, all storage controller actions can be performed through one middleware plug-in. This reduces the number of hops between the storage controller and the one or more storage resources and provides a measurable improvement in efficiency and performance.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
installing a middleware plug-in on a server connected to a storage area network (SAN) environment including a plurality of pre-existing storage controllers and a corresponding plurality of distinct storage resources;
defining a plurality of storage resource pools (SRPs) through the middleware plug-in;
populating each SRP with one or more storage resources;
defining one or more user-roles through the middleware plug-in;
associating each SRP with a designated user-role; and
assigning each end-user to one or more user-roles through the middleware plug-in.

2. The computer-implemented method of claim 1, wherein the middleware plug-in is configured to act as an intermediary between the plurality of pre-existing storage controllers and the corresponding plurality of distinct storage resources.

3. The computer-implemented method of claim 1, wherein each distinct storage resource includes one or more storage resources that share a common storage format.

4. The computer-implemented method of claim 1, wherein each user role is configured to provide end-users with limited access to an associated SRP.

5. The computer-implemented method of claim 1, wherein the one or more storage resources populating each SRP are selected from any of the one or more distinct storage resources.

6. The computer-implemented method of claim 5, wherein each SRP is configured to be cross-compatible with one or more different storage formats simultaneously.

7. The computer-implemented method of claim 1, wherein each user role is configured to apply a pre-determined set of policies through the middleware plug-in.

8. The computer-implemented method of claim 1, wherein each SRP is configured to receive a pre-determined set of services through the middleware plug-in.

9. A computing system comprising:
a memory; and
a processor configured to install a middleware plug-in on a server connected to a storage area network (SAN) environment, the SAN environment including a plurality of pre-existing storage controllers and a corresponding plurality of distinct storage resources, to define two or more SRPs (storage resource pools), to populate each SRP with one or more storage resources, to define one or more user-roles, to associate each SRP with a designated user-role, and to assign each end-user to one or more user roles.

10. The computing system of claim 9, wherein each user role is configured to provide end-users with limited access to an associated SRP.

11. The computing system of claim 9, wherein the one or more storage resources populating each SRP are selected from any of the one or more distinct storage resources, and wherein each SRP is configured to be cross-compatible with one or more different storage formats simultaneously.

12. The computing system of claim 9, wherein each user role is configured to apply a pre-determined set of policies through the middleware plug-in.

13. The computing system of claim 9, wherein each SRP is configured to receive a pre-determined set of services through the middleware plug-in.

14. The computing system of claim 9, wherein the one or more storage resources populating each SRP are selected from any of the one or more distinct storage resources.

15. A computer program product residing on a non-transitory computer readable medium having a plurality of instructions stored thereon which, when executed by a processor, cause the processor to perform operations comprising:
defining two or more SRPs (storage resource pools);
populating each SRP with one or more storage resources;
defining one or more user-roles;
associating each SRP with a designated user-role; and
assigning each end-user to one or more user-roles.

16. The computer program product of claim 15, the one or more storage resources populating each SRP reside on one of a plurality of distinct storage resources, and wherein the one or more storage resources share a common storage format.

17. The computer program product of claim 16, wherein the one or more storage resources populating each SRP are selected from any of the one or more distinct storage resources, and wherein each SRP is configured to be cross-compatible with one or more different storage formats simultaneously.

18. The computer program product of claim 15, wherein each user role is configured to provide end-users with limited access to an associated SRP.

19. The computer program product of claim 15, wherein each user role is configured to apply a pre-determined set of policies.

20. The computer program product of claim 15, wherein each SRP is configured to receive a pre-determined set of services.
